(19) United States
(12) Patent Application Publication
(10) Pub. No.: US 2004/0092671 A1
(43) Pub. Date: May 13, 2004

(54) Use of modified polyamine amides for hydrophilizing surfaces

(76) Inventors: Cordula Mock-Knoblauch, Ludwigshafen (DE); Michael Zirnstein, Schriesheim (DE); Helmut Meffert, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/473,113

(22) PCT Filed: Mar. 25, 2002
(86) PCT No.: PCT/EP02/03346

(30) Foreign Application Priority Data
Mar. 28, 2001 (DE) 101 15 256.6

(51) Int. Cl. C08L 77/00

(52) U.S. Cl. 525/430

(57) ABSTRACT

Polyaminoamides in which at least some of the amine nitrogen atoms have been alkoxylated, amidated, or alkylated are suitable for hydrophilicizing surfaces, in particular of linear or sheet-like textile structures made from synthetic fibers, or structures in the form of their plastics film or of a plastics molding. The hydrophilicized linear or sheet-like textile structures are particularly used in hygiene items.

The present invention relates to the use of certain polyaminoamides for hydrophilicizing the surfaces of particulate, linear, sheet-like, or three-dimensional structures.

Articles made from synthetic materials, such as thermosets or thermoplastics, generally have hydrophobic surface properties. However, hydrophobic properties are frequently undesirable if adhesive, or a coating or ink or paint or lacquer, is to be applied to the articles, since most adhesives, coating compositions and paints give only inadequate adhesion to hydrophobic surfaces. Hydrophobic properties are also undesirable in textile sheets, in particular in nonwovens. Examples of uses of nonwovens are cloths for cleaning, wiping or dishwashing, and serviettes. In these applications it is important that when spilled liquids, for example, such as milk, coffee, etc. are wiped up they are rapidly and fully absorbed, and that wet surfaces are dried as fully as possible. The absorption of liquids by a cleaning cloth becomes more rapid as their transport on the fiber surface becomes faster, and fibers with a hydrophilic surface are readily and rapidly wetted by aqueous liquids.

There are various conventional processes for hydrophilicizing the surfaces of films or moldings. For example, the surfaces of plastic items can be activated by gaseous fluorine. However, this process requires operations using the highly poisonous gas fluorine, with increased apparatus costs. Corona and plasma treatments are other processes used to increase the hydrophilic character of the surface of various materials, such as plastics or metals.

To improve the water-absorption properties of nonwovens, use is also made of surface-active hydrophilicizing agents, such as emulsifiers, surfactants, or wetting agents. These give excellent initial hydrophilic properties. However, a disadvantage of these nonwovens is that the hydrophilic agents are gradually washed out by water or other aqueous media.

After repeated contact with water, the product becomes increasingly hydrophobic. Another disadvantage of the known surface-active agents is a marked reduction in the surface tension of water so that in many applications, in particular in nonwovens used for sanitary or diaper applications, there is an undesirable increase in the susceptibility to permeation and in the wetting power of the liquid absorbed.

WO 98/27263 discloses stably hydrophilic polymer coatings for fibers made from polyester or from polypropylene or the like. The coating comprises certain polyoxypropylamines or polypropylene oxide polymers or hydrophilic polyester copolymers containing ethylene terephthalate units.

WO 97/00351 describes durably hydrophilic polymer coatings for polyester fibers, polyethylene fibers, or polypropylene fibers, and for the corresponding woven fabrics. The coatings comprise hydrophilic copolyesters, and also polypropylene oxide polymers.

WO 94/00418 describes chain-extended polyamines having at least one fatty acid radical. One of the uses of the compounds is as a size for fibers.

GB 1218394 describes a process for preparing a water-soluble hot-curing polymer by reacting a dicarboxylic acid with a polyalkylene polyamine to give a polyaminoamide, which is reacted with an alkylene oxide. The product of the reaction is then further reacted with epichlorohydrin or epibromohydrin.

It is an object of the present invention to provide other hydrophilicizing compounds which have a high level of hydrophilicizing action and a high level of permanency on the surfaces treated with the same.

We have found that this object is achieved by using polyaminoamides in which at least some of the amine nitrogen atoms bear radicals of the formula I, II and/or III, for hydrophilicizing the surface of particulate, linear, sheet-like, or three-dimensional structures

(CH₂—CR¹R²—O)ₘH (I)

where

R¹ is hydrogen, C₁-C₂₈-alkyl, C₂-C₂₈-alkenyl, C₆-C₁₆-aryl, or C₇-C₁₆-arylalkyl,

R² is hydrogen or methyl, and

m is from 1 to 100;

R³—CO— (II)

where

R³ is hydrogen, C₁-C₂₇-alkyl, C₂-C₂₇-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ may be identical or different and are hydrogen, alkyl, or acyl;

R⁴— (III)

where

R⁴ is C₁-C₂₈-alkyl, C₂-C₂₈-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ are as defined above.

Polyaminoamides whose use is preferred encompass repeat units of the formula IV

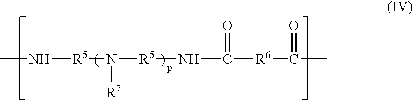

where

P is an integer from 1 to 20, preferably from 2 to 10, in particular from 2 to 5,

R⁵ is identical or different C₂-C₈-alkylene, preferably C₂-C₃-alkylene,

R⁶ is the radical of a dicarboxylic acid (after removal of the carboxyl groups), where this radical may be identical or different in each of the repeat units, and preferably a chemical bond or C₁-C₈-alkylene, where the latter may be interrupted by a double bond, by an oxygen atom or by an imino group, or may bear one or more hydroxyl groups and/or amino groups, and

R⁷ is hydrogen or a radical of the formulae I, II and/or III, where at least some of the radicals R⁷ are not hydrogen.

Besides the repeat units of the formula IV, the polyaminoamide may optionally have repeat units of the formula V

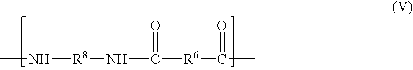

where

R⁶ is as defined above, and

R⁸ is C₂-C₅₀₀-alkylene which may have interruption by oxygen atoms or tertiary nitrogen atoms separated from one another by at least two carbon atoms, or may be anellated with saturated or unsaturated carbo- or heterocyclic, preferably 6-membered, rings.

Typical examples of R⁸ are

—(CH₂)ₙ— where n=from 1 to 6

| | |
|---|---|
| 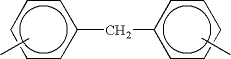 | |
| 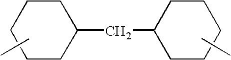 | |
| 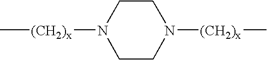 | where x = 2 or 3 |
| —(CH₂—CHR—O)_{z}—CH₂—CH₂— | where R = H or CH₃z = from 2 to 100 |
| 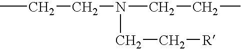 | where R′ is a radical encompassing repeat units of the formula IV and/or V. |

The proportion of the repeat units of the formula IV is preferably at least 20 mol %, in particular at least 50 mol %, based on the entirety of the repeat units of the formulae IV and V.

The number of the repeat units of the formula IV or the total number of repeat units of the formulae IV and V if the latter are present, is generally from 5 to 250, preferably from 20 to 100, in the polyaminoamides used according to the invention.

From 5 to 100%, in particular from 15 to 100%, of the amino nitrogen atoms in the polyaminoamide preferably bear a side chain of the formula 1, II or III.

For the purposes of the present invention, C₁-C₂₇-alkyl here and below is a linear or branched alkyl radical having from 1 to 27 carbon atoms, e.g. methyl, methyl, ethyl, n-propyl, isopropyl, n-butyl, 1-methylpropyl, 2-methylpropyl, 1,1-dimethylethyl, n-pentyl, 1-methylbutyl, 2-methylbutyl, 3-methylbutyl, n-hexyl, n-octyl, ethylhexyl, 1,1,3,3-tetramethylbutyl, n-nonyl, n-decyl, n-undecyl, n-dodecyl, n-tridecyl, myristyl, pentadecyl, palmityl (=cetyl), heptadecyl, octadecyl, nonadecyl, arachinyl, behenyl, lignocerenyl, cerotinyl, melissinyl etc. Among these, preference is given to linear or branched radicals having from 2 to 8, in particular from 2 to 6, carbon atoms.

For the purposes of the present invention, C₁-C₂₈-alkyl is C₁-C₂₇-alkyl as defined above and any linear or branched alkyl radicals having 28 carbon atoms.

C₂-C₂₇-Alkyl is a linear or branched hydrocarbon radical having from 2 to 27 carbon atoms and having one, two or three double bonds, which may be conjugated or unconjugated. Examples here are vinyl, allyl, 1-methylvinyl, methallyl, 1-butenyl, octenyl, nonenyl, decenyl, undecenyl, dodecenyl, tridecenyl, tetradecenyl, pentadecenyl, hexadecenyl, heptadecenyl, octadecenyl, nonadecenyl, linolyl, linolenyl, elaostearyl etc. Among these, preference is given to linear or branched radicals having from 2 to 8, in particular from 2 to 6, carbon atoms.

C₂-C₂₈-Alkenyl is C₂-C₂₇-alkenyl as defined above and in addition any linear or branched alkyl radical having 28 carbon atoms and having one, two or three double bonds, which may be conjugated or unconjugated.

C₆-C₁₆-Aryl is an aromatic radical having from 6 to 16 carbon atoms, e.g. phenyl or naphthyl, which may, where appropriate, have substitution, e.g. by one, two or three substituents selected from the class consisting of halogen, C₁-C₄-alkyl, e.g. methyl and ethyl, and C₁-C₄-alkoxy, e.g. methoxy and ethoxy.

C₇-C₁₆-Arylalkyl is an alkyl radical, preferably having 1, 2, 3 or 4 carbon atoms, which bears an aromatic radical having from 6 to 16 carbon atoms, as defined above. Examples here are benzyl, 1-phenylethyl, and 2-phenylethyl.

In formula I, R¹ is identical or different radicals, preferably methyl, ethyl, n-propyl, n-butyl, phenyl, or vinyl, and R² is preferably hydrogen.

A particular embodiment of the invention is given by polyaminoamides having side chains of the formula Ia

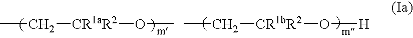

where

R^{1a} and R^{1b}, independently of one another, are hydrogen, C₁-C₂₈-alkyl, C₂-C₂₈-alkenyl, C₆-C₁₆-aryl, C₇-C₁₆-arylalkyl, where the number of carbon atoms in the radicals R^{1a} and R^{1b} differs by at least 1,

R² is as defined above,

m′ is an integer from 1 to 20, e.g. 1, and

m″ is an integer from 1 to 99, preferably from 1 to 20,

and where m′+m″=m.

The value of m averaged over the number of amino nitrogen atoms in the polyaminoamide is preferably at least 0.15, in particular at least 0.25, particularly preferably at least 0.5, e.g. about 1. The average does not generally exceed 10.

The radical R³ in formula II is generally unsubstituted or has one, two, three or four substituents, selected from the group consisting of hydroxyl, alkoxy, alkoxycarbonyl, and NE₁E₂. The maximum achievable degree of substitution here is generally limited only by the chain length of the radical R³.

If R³ bears a hydroxyl substituent, R³ preferably derives from a hydroxycarboxylic acid via removal of the carboxyl group. Examples of preferred hydroxycarboxylic acids are C₂-C₇ monohydroxycarboxylic acids, e.g. glycolic acid, lactic acid, 4-hydroxybutyric acid, 5-hydroxypentanoic acid, 6-hydroxyhexanoic acid, and mixtures of these. Other suitable monohydroxycarboxylic acids are C₈-C₂₈ monohydroxycarboxylic acids, e.g. 10-hydroxydecanoic acid, 11-hydroxyundecanoic acid, 12-hydroxystearic acid, ricinoleic acid, and also hydroxy fatty acids, these being obtainable by hydrogenating epoxy fatty acids, for example. Another way of obtaining suitable C₈-C₂₈ dihydroxycarboxylic acids is through hydrolytic ring-opening of epoxy fatty acids.

Amino groups on the radical R³ are preferably unsubstituted. As an alternative, they preferably have one or two C₁-C₆-alkyl groups or one C₁-C₆-acyl group.

If the radical R³ bears an amino substituent, the radical R³ preferably derives from a C₁-C₂₇ monoaminocarboxylic acid by removal of the carboxy group. Suitable aminocarboxylic acids include in particular 2-aminocarboxylic acids, such as glycine, alanine, valine, lysine, 6-aminohexanoic acid, 11-aminoundecanoic acid, and mixtures of these.

If the radical R³ is an aryl radical, it preferably derives from an aromatic carboxylic acid, hydroxycarboxylic acid, or aminocarboxylic acid via removal of the carboxy group. These preferably include benzoic acid, 2-hydroxybenzoic acid, 3-hydroxybenzoic acid, 4-hydroxybenzoic acid, 2-aminobenzoic acid, 3-aminobenzoic acid, 4-aminobenzoic acid, 1-naphthalenecarboxylic acid, 2-naphthalenecarboxylic acid, 1-hydroxy-2-naphthoic acid, 2-hydroxy-1-naphthoic acid, 2-hydroxy-3-naphthoic acid, 6-hydroxy-2-naphthoic acid, 3-amino-1-naphthoic acid, 4-amino-1-naphthoic acid, 8-amino-1-naphthoic acid, and mixtures of these. The abovementioned aromatic hydroxy- and/or aminocarboxylic acids may also have been acylated or alkylated at the hydroxyl- and/or amino groups. Preference is given to C₁-C₆-alkyl radicals and acyl radicals.

R³ is particularly preferably C₂-C₂₇-alkyl, in particular C₂-C₁₂-alkyl, preferably unsubstituted or bearing one, two or three hydroxyl groups.

The radical R⁴ in the formula III is preferably C₃-C₁₃-alkyl, preferably bearing one, two or three hydroxyl groups.

Polyaminoamides are polymers whose backbone contains both amino functions and amide functions. They are obtainable by reacting polyalkylene polyamines with polycarboxylic acids, preferably in a molar ratio of from 1:0.5 to 1:2.

For the purposes of the present invention, polyalkylene polyamines are compounds which are composed of a saturated hydrocarbon chain having terminal amino functions and interrupted by at least one secondary amino group. They may also have branching via tertiary nitrogen atoms. Suitable polyalkylene polyamines include diethylenetriamine, triethylenetetramine, tetraethylenepentamine, pentaethylenehexamine, diaminopropyl-ethylenediamine (═N,N′-bis(3-aminopropyl)-1,2-diaminoethane), ethylenepropylenetriamine, 3-(2-aminoethyl)aminopropylamine, dipropylenetriamine, and also polyethyleneimines with molecular weights preferably from 300 to 20 000, in particular of from 300 to 5 000. Preference is given to poly-C₂-C₃-alkyleneamines having from 3 to 10 nitrogen atoms. Among these, particular preference is given to diethylenetriamine, 3-(2-aminoethyl)aminopropylene, dipropylenetriamine, and diaminopropylethylenediamine. Mixtures of the polyalkylene polyamines with one another may, of course, also be used.

Besides use of the abovementioned polyalkylene polyamines in preparing the polyaminoamides, use may also be made of diamines whose hydrocarbon chain, where appropriate, has interruption by one or more oxygen atoms and/or tertiary nitrogen atoms. However, the polyalkylene polyamines preferably make up at least 20 mol %, in particular at least 50 mol %, of the amine component used. Examples of suitable diamines are ethylenediamine, propylene-diamine, 1,4-diaminobutane, 1,6-hexamethylenediamine, neopentane-diamine, 4,4′-diaminodiphenylmethane, 4,4′-diaminodicyclohexyl-methane, 3,3′-dimethyl-4,4′-diaminodiphenylmethane, N,N′-bis(2-aminoethyl)piperazine, N,N′-bis(3-aminopropyl)piperazine, and phenylenediamine.

Other diamines which may be used are αω-diamino compounds which derive from polyalkylene oxides or polytetrahydrofuran. Examples of compounds from which the polyalkylene oxides derive are ethylene oxide, propylene oxide, butylene oxide, and mixtures of these. The polyalkylene oxides usually contain from 2 to 100, preferably from 2 to 20, alkylene oxide units. It is preferable to start from polyethylene oxides or from polypropylene oxides or from block copolymers made from ethylene oxide and propylene oxide, where these may contain any desired ratio of ethylene oxide and propylene oxide incorporated into the polymer. α,ω-Diamines are obtained from the polyalkylene oxides mentioned or polytetrahydrofuran by reacting these with ammonia under pressure.

Polycarboxylic acids which may be used for preparing the polyaminoamides are dicarboxylic acids or higher carboxylic acids. Particularly suitable dicarboxylic acids are those having from 2 to 10 carbon atoms, for example oxalic acid, malonic acid, succinic acid, tartaric acid, maleic acid, itaconic acid, glutaric acid, adipic acid, suberic acid, sebacic acid, phthalic acid, or terephthalic acid. Other suitable acids are dibasic amino acids, such as iminodiacetic acid, aspartic acid, and glutamic acid. Examples of suitable higher polycarboxylic acids are butanetetracarboxylic acid, propanetricarboxylic acid, and citric acid. Preferred acids are adipic acid, glutaric acid, aspartic acid, and iminodiacetic acid. It is, of course, also possible to use mixtures of the polycarboxylic acids with one another.

The polycarboxylic acids may be used in the form of the free acids or as carboxylic acid derivatives, such as anhydrides, esters, amides, or acid halides, in particular acid chlorides. Examples of such derivatives are anhydrides such as maleic anhydride, succinic anhydride, phthalic anhydride, and itaconic anhydride; adipyl dichloride; esters preferably with C₁-C₂ alcohols, for example dimethyl adipate, diethyl adipate, dimethyl tartrate, and dimethyl iminodiacetate; amides, such as the mono- or diamide of adipic acid and the diamide of glutaric acid. It is preferable to use the free carboxylic acids or the carboxylic anhydrides.

The polyamine and the polycarboxylic acid are polycondensed in the usual way by heating the polyamine and the polycarboxylic acid, e.g. to 100-250° C., preferably 120 to 200° C., and distilling off the water formed during the condensation reaction. If use is made of the carboxylic derivatives mentioned, the condensation may also be carried out at temperatures lower than those given. The polyaminoamides may be prepared without adding a catalyst or with use of an acidic or basic catalyst. Examples of suitable acidic catalysts are acids such as Lewis acids, examples being sulfuric acid, p-toluenesulfonic acid, phosphorous acid, hypophosphorous acid, phosphoric acid, methanesulfonic acid, boric acid, aluminum chloride, boron trifluoride, tetraethyl orthotitanate, tin dioxide, dibutyltin dilaurate, and mixtures of these. Examples of suitable basic catalysts are alkoxides, such as sodium methoxide or sodium ethoxide, alkali metal hydroxides, such as potassium hydroxide, sodium hydroxide, or lithium hydroxide, alkaline earth metal oxides, such as magnesium oxide or calcium oxide, alkali metal or alkaline earth metal carbonates, such as sodium carbonate, potassium carbonate and calcium carbonate, phosphates, such as potassium phosphate, and complex metal hydrides, such as sodium borohydride. The amount of the catalyst, if used, is generally from 0.05 to 10% by weight, preferably from 0.5 to 1% by weight, based on the total amount of starting materials.

The reaction may be carried out in a suitable solvent, or preferably with no solvent. If a solvent is used, examples of those suitable are hydrocarbons, such as toluene or xylene, acetonitrile, N,N-dimethylformamide, N,N-dimethylacetamide, N-methylpyrrolidone, diethylene glycol dimethyl ether, ethylene glycol dimethyl ether, ethylene carbonate, propylene carbonate, and the like. The solvent is generally distilled off during the reaction or once the reaction has ended. Where appropriate, this distillation may take place under an inert gas, such as nitrogen or argon.

Polyaminoamides having side chains of the formula I are obtainable by reacting the polyaminoamides with epoxides of the formula VI

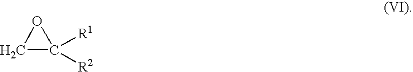

This forms side chains of the formula I on all or some of the amino groups of the polyaminoamides. The average value of m depends on the molar amount of epoxide, based on the number of amine nitrogen atoms available in the polyaminoamide.

Examples of preferred epoxides of the formula VI are propylene oxide, and also the epoxides of 1-buten (R¹=ethyl, R²═H; butylene oxide), of 1-p ntene (R¹=propyl, R²═H), of 1-hexene (R¹=n-butyl, R²═H), of styrene (R¹=phenyl, R²═H), and of butadiene (R¹=vinyl, R²═H).

Polyaminoamides which may be used according to the invention and have side chains of the abovementioned formula Ia are obtained by reacting the polyaminoamides first with epoxides of the formula VI, where R¹ is as defined for R^{1a}, and reacting the resultant primary alkoxylation products with an epoxide of the formula VI, where R¹ is as defined for R^{1b}. The polyaminoamide may therefore, for example, first be reacted with butylene oxide, pentene oxide, or styrene oxide, and the product of the primary reaction may then be further reacted with ethylene oxide and/or propylene oxide.

To obtain polyaminoamides having side chains of the formula I where the average of m over the amine nitrogen atoms is 1 or less, the polyaminoamides are generally reacted with an epoxide in the absence of any catalyst. Use is generally made here of an aqueous solution of the polyaminoamide. If longer chains are desired, the primary alkoxylation product is then reacted with the same, or another, alkylene oxide in the presence of an acidic or basic catalyst in an anhydrous solvent. Suitable acidic catalysts are acids, such as sulfuric acid or para-toluenesulfonic acid, or Lewis acids, such as tetraethyl orthotitanate, and the like. Suitable basic catalysts are bases such as potassium hydroxide, potassium tert-butoxide, and sodium methoxide.

Suitable solvents are C₁-C₄-alkanols, tetrahydrofuran, dioxane, dimethylformamide, and mixtures of these. It is also possible to use aliphatic or aromatic hydrocarbons, such as hexane, cyclohexane, toluene, xylenes, and similar solvents.

The temperature for the reaction is generally above 40° C., preferably from 70 to 150° C., in particular from 75 to 110° C.

The reaction may take place in the reactors usually used for this purpose. If use is made of volatile starting materials, such as butylene oxide, or if the reaction temperature is above 100° C., it is preferable to operate in closed reaction vessels. The use of increased pressure is in principle not required. However, it may be advantageous when reacting volatile components. The pressure for the reaction may then be up to 50 bar, preferably up to 10 bar.

Polyaminoamides of the invention having side chains of the formula II may be obtained by reacting polyaminoamides with a compound of the formula VII

R³—CO—X (VII)

where

R³ is as defined above. X is a leaving group capable of nucleophilic displacement, in particular hydroxyl, alkoxy, acyloxy, or halogen, in particular chlorine. The compound of the formula VI is therefore a carboxylic acid of the formula R³—COOH or an ester, or in particular an anhydride or a halide, in particular a chloride.

The amidation may be carried out under conventional conditions without addition of any catalyst, or using an acidic or basic catalyst. Suitable catalysts are those mentioned above with reference to the preparation of the underlying polyaminoamides. The reaction may be carried out in a suitable solvent, or preferably without any solvent. Suitable solvents and reaction conditions are those mentioned above in relation to the preparation of the underlying polyaminoamides.

It is preferable that from about 5 to 100%, in particular from 15 to 90%, of the amino nitrogen atoms in the polyaminoamide have been acylated.

Instead of reacting the abovementioned polyaminoamide with the carboxylic acid R³COOH or with a derivative thereof, an alternative is to add this acid before completing the preparation of the polyaminoamide. Polyaminoamides which may be used according to the invention and have side chains of the formula II may therefore be obtained by polycondensing a polyamine with a polycarboxylic acid and with a monocarboxylic acid of the formula R³COOH. The polycarboxylic acid and the monocarboxylic acid of the formula R³COOH may be used as such or in the form of a derivative, such as an anhydride, ester, or halide. It is preferable for the molar ratio used of polyalkylene polyamine, polycarboxylic acid, and monocarboxylic acid to b 1:(0.5-1.5):(0.05-3).

As another alternative, the polyamine may be partially amidated with a monocarboxylic acid of the formula R³COOH or with a derivative thereof before the polyaminoamid is prepared, and may then be reacted with a polycarboxylic acid or with a derivative thereof to give a polyaminoamide which can be used according to the invention and has side chains of the formula II.

Polyaminoamides of the invention having side chains of the formula III may be obtained by reacting a polyaminoamide with an alkylating agent of the formula VIII

R⁴—Y (VIII)

where R⁴ is as defined above and Y is a leaving group capable of nucleophilic displacement, for example halogen, in particular chlorine, bromine, or iodine, or an activated hydroxyl group, such as tosyloxy.

Polyaminoamides of the invention are also obtained when polyaminoamides in which some of the amine nitrogen atoms bear side chains of the formula II and/or III are reacted as described with epoxides of the formula VI. It is also possible to begin by modifying some of the amine nitrogen atoms with radicals of the formula II and to modify at least some of the remaining nitrogen atoms with radicals of the formula III, or vice versa.

The polyaminoamides having side chains of the formula I, II and/or III are advantageously suitable for hydrophilicizing the surface of particulate, linear, sheet-like, or three-dimensional structures.

Particulate structures are particularly those with a particle size of from 1 nm to 10 mm, in particular from 10 nm to 1 mm, preferably dispersed or dispersible in a medium. Examples which may be mentioned are pigments, mineral or metallic fillers, and non-living organic materials.

For the purposes of the present invention, linear-type structures are in particular fibers, filaments, yarns, threads, and the like. Structures of this type are also termed linear textile structures.

For the purposes of the present application, linear textile structures also include textile composites, e.g. carpets, backed textiles, laminated textiles, etc.

Sheet-like structures are particularly textile structures, such as wovens, knits, felts, webs, and nonwovens, preferably the latter. A nonwoven is produced by laying down a web of fibers which is then consolidated by various processes to give nonwovens. For example, the web is treated with an aqueous binder, such as a polymer latex, and then, where appropriate after removal of excess binder, dried and, where appropriate, cured. Other sheet-like structures are films, paper, and comparable two-dimensional structures.

Three-dimensional structures are generally moldings of various dimensions. They include in particular moldings made from wood, from paper, from metals, from plastics, from ceramic substrates, and from woven fabrics composed of natural or synthetic fibers in the form of fluffs, tissues, etc.

Preferred embodiments of the hydrophilicized structures of the invention are linear or sheet-like textile structures. Other preferred embodiments of the structure of the invention are plastics films and plastics moldings. The linear or sheet-like textile structures hydrophilicized according to the invention are particularly suitable for use in hygiene items, in particular single-use hygiene items, such as diapers, sanitary napkins, panty liners, wound dressings, and the like.

For the purposes of the present invention, hydrophilicization is an improvement in the wettability with water or with an aqueous liquid. Improved wettability is generally accompanied by more rapid and/or more extensive absorption of liquid and/or by improved liquid retention, generally also under pressure.

The hydrophilicized structures of the invention are generally suitable with advantage for any of the application sectors where water or aqueous liquids come into contact with materials which in their unmodified state are substantially hydrophobic. This includes in particular the fast absorption and/or the fast transport of water into materials which are intrinsically hydrophobic. The structures may also generally be used with advantage wherever hydrophilicization can achieve improved adhesion properties, improved antistatic properties, improved anti-deposition properties, improved hand, and/or improved wearer comfort.

The hydrophilicized structures of the invention are suitable with advantage in, or as, synthetic fibers, wovens, knits, nonwovens, felts, textile composites, e.g. carpets, backed or laminated textiles, etc. They are suitable with advantage for use in diapers, hygiene inserts, cloths for cleaning, wiping, or dishwashing, serviett s, agricultural textiles, geotextiles, and filter applications.

The structures used encompass at least one naturally occurring or synthetic polymeric material.

Examples of such materials are:

1. Polymers of mono- and diolefins, for example polypropylene, polyisobutylene, poly-1-butene, poly-4-methyl-1-pentene, polyisoprene, and polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HDPE-HMW), high-density ultra-high-molecular-weight polyethylene (HDPE-UHMW), medium-density polyethylene (MDPE), low-density polyethylene (LDPE), linear low-density polyethylene (LLDPE), and branched low-density polyethylene (VLDPE).

Polyolefins, i.e. the monoolefin polymers mentioned by way of example in the section above, in particular polyethylene and polypropylene, may be prepared by various processes, in particular free-radical processes, or by way of a catalyst, the catalyst usually comprising one or more metals of group IVb, Vb, VIb, or VIII. These catalyst systems are usually termed Phillips, Standard Oil Indiana, Ziegler(-Natta), TNZ (DuPont), metallocene, or single-site catalysts (SSC).

2. Mixtures of the polymers mentioned in 1., e.g. mixtures of polypropylene with polyisobutylene, polypropylene with polyethylene (e.g. PP/HDPE, PP/LDPE), and mixtures of different polyethylene grades (e.g. LDPE/HDPE).

3. Copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, or with polymers m ntioned in 1., e.g. polypropylen/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

4. Hydrocarbon resins, including hydrogenated modifications of these (e.g. tackifier resins), and mixtures of polyalkylenes and starch.

5. Polystyrene, poly(p-methylstyrene), poly(α-methylstyrene).

6. Copolymers of styrene or α-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

7. Graft copolymers of styrene or α-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtur s of these with the copolymers mentioned in 6., e.g. those known as ABS polymers, MBS polymers, ASA polymers, or AES polymers.

8. Halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

9. Polymers derived from α,β unsaturated acids or from derivatives of these, for example polyacrylates and polymethacrylates, butyl-acrylate-impact-modified polymethyl methacrylates, polyacrylamides, and polyacrylonitriles.

10. Copolymers of the monomers mentioned in 9. with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

11. Polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; and copolymers of these with olefins mentioned in 1.

12. Homo- and copolymers of cyclic ethers, for example polyalkylene glycols, polyethylene oxide, polypropylene oxide, and copolymers of these with bisglycidyl ethers.

13. Polyacetals, such as polyoxymethylene, and polyoxymethylenes which contain comonomers, e.g. ethylene oxide; polyacetals modified with thermoplastic polyurethanes, with acrylates, or with MBS.

14. Polyphenylene oxides and polyphenylene sulfides, and mixtures of these with styrene polymers or with polyamides.

15. Polyurethanes d rived, on the one hand, from polyethers, polyesters, or polybutadi nes having terminal hydroxyl groups and, on the other hand, from aliphatic or aromatic polyisocyanates, and also precursors of th se polyurethanes.

16. Polyamides and copolyamides derived from diamines and dicarboxylic acids, and/or from aminocarboxylic acids, or from the corresponding lactams, for example nylon-4, nylon-6, nylon-6,6, -6,10, -6,9, -6,12, -4,6, -12,12, -11, and -12, aromatic polyamides, e.g. those based on p-phenylenediamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

17. Polyureas, polyimides, polyamideimides, polyetherimides, polyesterimides, polyhydantoins, and polybenzimidazoles.

18. Polyesters which derive from dicarboxylic acids and dialcohols and/or from hydroxycarboxylic acids, or from the corresponding lactones, for example polyethylene terephthalate, polybutylene terephthalate, poly-1,4-dimethylolcyclohexane terephthalate, polyhydroxybenzoates, and also block polyetheresters which derive from polyethers having hydroxyl end groups; polyesters modified with polycarbonates or with MBS.

19. Polycarbonates and polyester carbonates.

20. Polysulfones, polyether sulfones, and polyether ketones.

21. Crosslinked polymers which derive from aldehydes on the one hand and from phenols, urea or melamine on the other, for example phenol-formaldehyde resins, urea-formaldehyde resins, and melamine-formaldehyde resins.

22. Drying and nondrying alkyd resins.

23. Unsaturated polyester resins which d rive from copolyesters of saturated or unsaturated dicarboxylic acids with polyhydric alcohols, and also vinyl compounds as crosslinkers, and also halogen-containing, flame-r tardant modifications of these.

24. Crosslinkable acrylic resins which derive from substituted acrylic esters, e.g. from epoxyacrylates, from urethane acrylates, or from polyester acrylates.

25. Alkyd resins, polyester resins, and acrylate resins which have been crosslinked by melamine resins, by urea resins, by isocyanates, by isocyanurates, by polyisocyanates, or by epoxy resins.

26. Crosslinked epoxy resins which derive from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

27. Natural polymers, such as cellulose, natural rubber, gelatine, and also their polymer-homologous chemically modified derivatives, for example cellulose acetates, cellulose propionates, and cellulose butyrates and the cellulose ethers, such as methylcellulose; and colophony resins and derivatives.

28. Binary or multiple mixtures (polymer blends) of the abovementioned polymers are also very generally suitable, e.g. PP/EPDM, nylon/EPDM or ABS, PVC/EVA, PVC/ABS, PVC/MBS, PC/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/nylon-6,6 and copolymers, PA/HDPE, PA/PP, PA/PPO, PBT/PC/ABS, and PBT/PET/PC.

Preference is given to those particulate, linear, sheet-like or three-dimensional structures which encompass at least one polymeric material selected from the group consisting of polyolefins, polyesters, polyamides, polyacrylonitrile, polyaromatics, styrene-acrylonitrile copolymers (SAN), acrylonitrile-butadiene-styrene copolymers (ABS), polyurethanes, and mixtures (polymer blends) of the abovementioned polymers.

Linear or sheet-like textile structures built up from synthetic fibers, in particular from those made from polyolefins, such as polyethylene or polypropylen, or from polyesters, polyacrylonitrile, or polyamides, e.g. nylon-6 or nylon-6,6, are hydrophilicized with advantage according to the invention.

Other suitable sheet-like structures are films and sheeting. These preferably encompass a polymer selected from the group consisting of polyolefins, such as polyethylene and/or polypropylene, polymers of halogenated monomers, e.g. polyvinyl chloride and/or polytetrafluoroethylene, polyesters, and mixtures of these. The hydrophilicization of the invention improves their printability and adhesion capability, and also their antistatic properties.

Three-dimensional structures, i.e. moldings, whose surfaces may be hydrophilicized according to the invention preferably encompass at least one polymeric material selected from the group consisting of polyolefins, e.g. polyethylene and/or polypropylene, polyaromatics, such as polystyrene, polymers of halogenated monomers, such as polyvinyl chloride and/or polytetrafluoroethylene, polyesters, polyacrylonitrile, styrene-acrylonitrile copolymers (SAN), acrylonitrile-butadiene-styrene copolymers (ABS), polyamides, such as nylon-6 and/or nylon-6,6, polyurethanes, and mixtures of these. The use of the polyaminoamides of the invention having side chains of the formula I, II, and/or III likewise improves the surface properties of moldings, making these more printable or more capable of adhesion, or giving them better antistatic properties.

The polyaminoamides having side chains of the formula I, II, and/or III may be used in mixtures or in combination with surface-active substances, e.g. anionic, non-ionic, or cationic surfactants or, respectively, wetting agents. They may also be used in a mixture with other polymers, and in some circumstances this can also reinforce the surface-modifying action.

The processes used to equip the particulate, linear, sheet-like, or three-dimensional structures of the invention with the polyaminoamides used according to the invention may be those usually used to hydrophilicize the abovementioned structures with hydrophilicizing agents of the prior art. To this end, the structure is usually treated with a dilute, preferably aqueous, solution of the polyaminoamide in a manner usual for the nature of the structure, e.g. by rinsing, dipping, spraying, padding, or similar methods as usually used for treating textiles or films. Based on the weight of the solution, it generally comprises from at least 0.01 to 20% by weight, preferably from 0.05 to 15% by weight, and in particular from 0.1 to 10% by weight, of the polyaminoamides used according to the invention. It is pr ferable to use aqueous solutions of th polyaminoamides for the treatment. The required amount of polyaminoamide used according to the invention for hydrophilicization is absorbed by the surface and remains adhering thereto after drying. The amounts required to achieve effective hydrophilicization are reached automatically and are extremely small. For structures with a smooth surface, such as films or similar structures, as little as 0.1 mg/m² of polyaminoamide is sufficient.

In an alternative method, the polyaminoamide used according to the invention may also be added to the material of which the structure is composed, and the structure may then be produced from this. For example, when treating thermoplastics, the polyaminoamide used according to the invention in the form of a solid may be compounded with the plastic. The resultant treated plastic is then further processed by conventional processes to give films, for example, by extrusion, or to give fiber materials, for example by a melt spinning process.

The ease of use of the polyaminoamides used according to the invention permits their use in many application sectors, for example as hydrophilicizing agents for nonwovens used in diapers, hygiene inserts, agricultural textiles, geotextiles, other textiles, or filter systems, for example. Synthetic fibers hydrophilicized according to the invention may themselves be further processed to give textiles. The hydrophilicization usually also results in an improvement in water-vapor permeability and capillary transport of perspiration, and a reduction in soiling by a wide variety of hydrophobic types of dirt. In addition, there is a favorable effect on soil release properties. The polyaminoamides used according to the invention may also be used as an antistatic treatment for plastic films or silicon wafers.

A suitable measure for assessing the hydrophilic/hydrophobic nature of the surface of a particulate, linear, sheet-like, or three-dimensional structure is the contact angle of water on the respective surface (see, for example, Römpp, Lexikon Chemie, 9th Edition, p. 372 “Benetzung”, Georg Thieme Verlag (1995). The term hydrophobic surfaces is usually used here if the contact angle of water is above 90°. The use of the polyaminoamides having side chains of the formula I, II, and/or III brings about a reduction in the contact angle by at least 5°, preferably by at least 10°, compared with that of the unmodified hydrophobic surface.

The polyaminoamides used according to the invention, and also the structures surface-modified with the same, advantageously have particularly good compatibility with polymer melts. They are therefore generally also suitable as additives to a melt of polymeric raw materials for fibers or for moldings. However, they may also be used as agents for modifying the structures by post-treatment.

The invention is further illustrated by the following non-limiting examples.

I. Test Methods

I.1 Angle of Contact Measurement

The respective substrate is treated for 30 min at 21° C., with stirring, with a 0.5% strength by weight solution of the polyaminoamide used according to the invention. The specimen is dried immediately after the treatment. The contact angle is determined on the specimen using distilled water at room temperature.

I.2 Measurement of Hydrophilic Properties

The measurement took place on a polypropylene nonwoven, by treating the nonwoven with a 0.5% strength by weight aqueous solution of the polyaminoamide of the invention, followed by drying of the nonwoven. A drop of water is applied to the substrate to be tested. The wetting of the nonwoven by the water is assessed visually by way of a 10 point scale. 0 points here means no wetting, and 10 points means immediate run-out of the drop.

I.3 Reflectometric determination of affinity

As described by J. C. Dijt et al., Colloids Surf. 51 (1990) 141, a polypropylene film which was applied to a silicon wafer is brought into contact with an aqueous polymer solution at a concentration of 0.05% by weight. The amount adsorbed can be determined in situ by analyzing the polarization direction of a reflected beam of light.

### II. PREPARATION EXAMPLES

### Example 1

### Pentoxylated Polyaminoamide (>90% of the Aminic Nitrogens Reacted)

1357 g of a 60% strength aqueous polyaminoamide solution (adipic acid-diethylenetriamine 1:1 condensate, n=3.82 mol for amino groups in the mixture) and 329 g (3.82 mol) of pentene 1,2-oxide formed an initial charge at 30° C. in a 2 l metal reactor, which was then inertized three times, on each occasion using nitrogen at 5 bar. The reactor contents were heated to 90° C., with stirring, and held at 90° C. for 24 h. Cooling and depressurization of the reactor gave a clear, viscous solution, brown in color.

### Example 2

### Propoxylated Polyaminoamide (About 50% of Aminic Nitrogens Reacted)

2982 g of a 57% strength aqueous polyaminoamide solution (adipic acid-diethylenetriamine 1:1 condensate, (n=8.02 mol for amino groups in the mixture) forms an initial charge at 70° C. in a 5 metal reactor, which was then inertized three times, on each occasion using nitrogen at 5 bar. The reactor contents were heated to 80° C. and then 223 g (4.01 mol) of propene oxide were metered in until a pressure of 5 bar had been achieved. Stirring then continued until the pressure became constant. Cooling and depressurization of the reactor, and devolatilization on a rotary evaporator at 50° C. and 500 mbar gave a propoxylated polyaminoamide in which every second amine had been modified.

### Example 3

103.3 g of diethylenetriamine formed an initial charge in a 1 l stirred apparatus and were heated to 120° C. under nitrogen. Once this temperature had been achieved, 116.2 g of hexanoic acid were added dropwise and this was followed by heating to 170° C. Water produced in the reaction was distilled off. Once an acid value of about 10 mmol KOH/g had been achieved the mixture was allowed to cool to 140° C. and 146.2 g of adipic acid were introduced. After reheating to 170° C., the water from the reaction was distilled off until an acid value of 21.2 mg KOH/g and an amine value of 0.61 mmol N/g had been achieved. A 40% strength solution of the polyaminoamide modified with hexaxnoic acid was prepared by cooling, followed by addition of demineralized water.

### III. APPLICATION-RELATED EXAMPLES

III.1 Angle of Contact Measurement and Surface Tension Measurement

The angle of contact was measured as described above. The surfact tension was measured on solutions of 0.1% strength by weight in water, at 23° C. to DIN 53914. The results are given in Table 1 below.

TABLE 1

| | | Angle | Surface tension (0.1% |
|---|---|---|---|
| | | of | additive in water at |
| Example No. | Additive | contact | 23° C. to DIN 53914) |
| (Comparison) | no additive | 1050° | 72 mN/m |
| | | | (pure water) |
| (Comparison) | commercially | 58° | 29 mN/m |
| | available | | |
| | alcohol | | |
| | ethoxylate | | |
| (Comparison) | commercially | 86° | not measured |
| | available | | |
| | hydrophilicizing | | |
| | polyetherester | | |
| | Example 1 | 24° | 34 mN/m |
| | Example 2 | 28° | 55 mN/m |
| | Example 3 | 41° | 58 mN/m |

III.2: Measurement of Hydrophilic Properties

Hydrophilic properties were measured as described above. The results are given in Table 2 below.

TABLE 2

| | | Level of |
|---|---|---|
| | | hydrophilic |
| Example No. | Additive | properties |
| (Comparison) | no additive | 0 |
| (Comparison) | commercially available | 3 |
| | hydrophilicizing polyetherester | |
| | Example 1 | 8 |
| | Example 2 | 9 |

III.3: Determination of Affinity

A 0.05% by weight solution of the pentoxylated polyaminoamide from Example 1 was adjust d to a pH of 5. A polypropylene-modifi d silicon wafer was then subjected to a perpendicular flow of the resultant solution at 0.7 ml/min. A change in the detection signal compared with that from a polymer-free solution was observed, due to absorption of the polymer. Using computer-assisted jet modeling, this change gives a coating weight of 0.8 mg/m². The coating weight does not decrease significantly when polymer-free solution is then allowed to flow onto the surface.

The application-related examples show that polypropylene surfaces can be effectively hydrophilicized using the polyaminoamides used according to the invention. None of the inventive examples here reveals any significant tendency toward foaming, whereas the commercially available alcohol ethoxylate used as comparative substance shows a marked to very marked foaming tendency, as do the conventional non-ionic surfactants known from the prior art.

We claim:

1. The use of polyaminoamides, in which at least some of the amine nitrogen atoms bear radicals of the formula I, II and/or III, for hydrophilicizing the surface of particulate, linear, sheet-like, or three-dimensional structures
(CH₂—CR¹R²—O)ₘH (I)
where
R¹ is hydrogen, C₁-C₂₈-alkyl, C₂-C₂₈-alkenyl, C₆-C₁₆-aryl, or C₇-C₁₆-arylalkyl,
R² is hydrogen or methyl, and
m is from 1 to 100;
R³—CO— (II)
where
R³ is hydrogen, C₁-C₂₇-alkyl, C₂-C₂₇-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ may be identical or different and are hydrogen, alkyl, or acyl;
R⁴— (III)
where
R⁴ is C₁-C₂₈-alkyl, C₂-C₂₈-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ are as defined above.

2. The use as claimed in claim 1, where the polyaminoamide encompasses repeat units of the formula IV 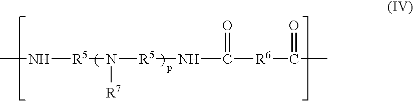
where
p is an integer from 1 to 20,
R⁵ is identical or different C₂-C₈-alkylene,
R⁶ is the radical of a dicarboxylic acid, and
R⁷ is hydrogen or a radical of the formulae I, II and/or III given in claim 1, where at least some of the radicals R⁷ are not hydrogen.

3. The use as claimed in claim 1 or 2, where from 5 to 100% of the amine nitrogen atoms of the polyaminoamide bear a radical of the formula I, II and/or III.

4. A particulate, linear, sheet-like, or three-dimensional structure comprising, at least, on its surface, a hydrophilicizing amount of at least one polyaminoamide, in which at least some of the amine nitrogen atoms bear radicals of the formula I and/or III
(CH₂—CR¹R²—O)ₘH (I)
where
R¹ is hydrogen, C₁-C₂₈-alkyl, C₂-C₂₈-alkenyl, C₆-C₁₆-aryl, or C₇-C₁₆-arylalkyl,
R² is hydrogen or methyl, and
m is from 1 to 100;
R⁴— (III)
where
R⁴ is C₁-C₂₈-alkyl, C₂-C₂₈-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ may be identical or different and are hydrogen, alkyl, or acyl.

5. A structure as claimed in claim 4, in the form of a linear or sheet-like textile structure.

6. A structure as claimed in claim 4, built up from synthetic fibers.

7. A hygiene item encompassing a structure as claimed in claim 5 or 6.

8. A hygiene item encompassing a linear or sheet-like textile structure which comprises, at least on its surface, a hydrophilicizing amount of at least one polyaminoamide, where at least some of the amine nitrogen atoms bear radicals of the formula II
R³—CO— (II)
where
R³ is hydrogen, C₁-C₂₇-alkyl, C₂-C₂₇-alkenyl, C₆-C₁₆-aryl or C₇-C₁₆-arylalkyl, where the alkyl, alkenyl, aryl, and arylalkyl groups may bear one or more substituents selected from the group consisting of hydroxyl, alkoxy, alkoxycarbonyl, and NE₁E₂, where E₁ and E₂ may be identical or different and are hydrogen, alkyl, or acyl.

9. A hygiene item as claimed in claim 8, in which the linear or sheet-like textile structure has been built up from synthetic fibers.
